(19) United States
(12) Patent Application Publication
(10) Pub. No.: US 2005/0089272 A1
(43) Pub. Date: Apr. 28, 2005

(54) Optical fiber collimator and manufacturing method thereof

(76) Inventor: Akihiko Tateiwa, Nagano-shi (JP)

Correspondence Address: MORGAN & FINNEGAN, L.L.P., 3 World Financial Center, New York, NY, 10281-2101, US

(21) Appl. No.: 10/971,269

(22) Filed: Oct. 22, 2004

(30) Foreign Application Priority Data
Oct. 24, 2003 (JP) 2003-363964

(51) Int. Cl. G02B 6/32

(52) U.S. Cl. 385/34; 385/124

(57) ABSTRACT

An optical fiber collimator is provided in which the optical axis of a beam of light incident upon and emergent from the end face of the optical fiber collimator utilizing graded index (GI) optical fiber is made to perfectly agree with the axial direction of the optical fiber and further the optical fiber collimator is capable of obtaining a return loss characteristic. The optical fiber collimator comprises: a single mode (SM) optical fiber and GI optical fiber fused to an end face of SM optical fiber so that an optical axis of SM optical fiber is coincide with an optical axis of GI optical fiber to effect an optical transmission between these fibers; and GI optical fiber having a second end face provided with a bulge portion defining a smooth outer surface symmetrical with respect to the common optical axis of SM and GI optical fibers.

### TECHNICAL FIELD

The present invention relates to an optical fiber collimator composed in such a manner that a graded index optical fiber (GIF) is fused to an end face of a single mode optical fiber (SMF), and light can be incident upon and emergent from an end face of the optical fiber in parallel with the axial direction of the optical fiber. The present invention also relates to a method of manufacturing the optical fiber collimator.

### BACKGROUND ART

FIGS. 4(a) and 4(b) are views showing the constitution of an optical fiber collimator in which a graded index optical fiber (GI optical fiber) is utilized. This collimator is formed when GI optical fiber 20 (wick wire) of a predetermined length, by which a collimating action is generated, is fused to an end face of the single mode optical fiber 10 (wick wire). Reference numeral 12 is a coating portion for coating a wick wire of the single mode optical fiber 10. In this specification, “wick wire” refers to an optical fiber composing a central core 10a, 20a and a clad 10b, 20b surrounding the central core.

This optical fiber collimator has the following actions. A luminous flux emergent from the core of the single mode optical fiber 10 is emergent from the end face of GI optical fiber 20, and a parallel luminous flux incident upon the end face of GI optical fiber 20 is condensed to the core of the single mode optical fiber 10. Concerning this constitution, refer to the official gazette of Japanese Unexamined Patent Publication No. 4-25805.

In this connection, when a facial direction of the end face of GI optical fiber 20 of this optical fiber collimator is perpendicular to the axial direction of the optical fiber as shown in FIG. 4(a), the following problems may be encountered. By Fresnel reflection on the end face of the optical fiber, a return loss on the end face of the optical fiber becomes approximately −15 to −18 dB. Therefore, even when an antireflection film, the transmittance of which is 99.9%, is provided on the end face of the optical fiber, the return loss is approximately −30 dB. Therefore, it is impossible to ensure a return loss characteristic in which the return loss must be not more than −50 dB from the viewpoint of practical use. Even in this case, when an antireflection film, the transmittance of which is 99.999%, is provided on the end face of GI optical fiber 20, it is possible to reduce the return loss to be not more than −50 dB. However, in order to provide such an antireflection film of high transmittance on the end face of GI optical fiber 20, it takes much labor work and manufacturing cost. Therefore, this method is not appropriate for practical use.

Therefore, it conventional to adopt the following method. When a facial direction of the end face of GI optical fiber 20 is inclined a little with respect to a face perpendicular to the axial direction of the optical fiber, it is impossible to improve the return loss characteristic. In order to form the end face of the optical fiber into the inclined face, a method of obliquely polishing the end face of the optical fiber is adopted. In the case of an optical fiber collimator, the end face of the optical fiber of which is formed into an inclined face as described above, when an antireflection film is provided on the end face, it is possible to obtain an excellent return loss characteristic in which the return loss is −70 dB.

In the case of an optical fiber collimator in which a plan of incidence and emergence of the optical fiber is inclined with respect to a direction perpendicular to the axial direction of the optical fiber, it is possible to obtain an excellent return loss characteristic on the end face of the optical fiber. However, in the case of an optical fiber collimator, the end face of the optical fiber of which is inclined, the following problems may be encountered. As shown in FIG. 4(b), a beam of light is refracted on the end face of GI optical fiber 20. Therefore, the axial direction of the optical fiber and the optical axis of a beam of light emergent from and incident upon the end face of the optical fiber are not aligned on a straight line. Accordingly, it becomes difficult to assemble the optical device.

The optical device in which optical parts are combined with each other must be assembled under the condition that optical axes of parts are made to accurately agree with each other. However, like the optical fiber collimator shown in FIG. 4(b), in the case where the axial direction of the optical fiber and the direction of the optical axis of a parallel luminous flux emergent from the end face of the optical fiber are different from each other, in order to make the optical axis accurately agree with another, a support structure for accurately positioning the optical fiber in the axial direction is required. In order to accurately support the optical fiber, parts of this support structure for supporting the optical fiber must be accurately machined. Further, in the case of supporting the optical fiber by the support parts, the rotational position of the optical fiber must be accurately positioned in the rotational direction round the axis. Furthermore, the end face position of the optical fiber must be accurately positioned. Therefore, the assembling work must be highly accurately performed.

As described above, in the case of an optical fiber collimator, the end face of the optical fiber of which is formed into an inclined face, the assembling work is complicated, which has been a problem to be solved.

### SUMMARY OF THE INVENTION

The present invention has been accomplished to solve the above problem. It is an object of the present invention to provide an optical fiber collimator in which the optical axis of a beam of light incident upon and emergent from the end face of the optical fiber collimator utilizing GI optical fiber is made to perfectly agree with the axial direction of the optical fiber and further the optical fiber collimator is capable of obtaining a return loss characteristic of not more than −50 dB on the end face of the optical fiber. It is another object of the present invention to provide a preferable method of manufacturing the optical fiber collimator.

According to this invention, there is provided an optical fiber collimator comprising: a single mode optical fiber having an end face thereof; a graded index optical fiber having a first end face fused to the end face of the single mode optical fiber so that an optical axis of the single mode optical fiber is coincide with an optical axis of graded index optical fiber to effect an optical transmission between these fibers; and the graded index optical fiber having a second end face provided with a bulge portion defining a smooth outer surface symmetrical with respect to the common optical axis of the single mode and graded index optical fibers.

It is preferable that the bulge portion is formed integrally with the graded index optical fiber.

The graded index optical fiber comprises a central graded index core extending along the optical axis thereof and a clad surrounding the core, and the bulge portion is formed at the graded index optical fiber.

It is preferable that the bulge portion is formed by etching the second end of the graded index core.

It is also preferable that the second end face of the graded index core is coated with an antireflection film.

According to another aspect of the present invention, there is provided a method of manufacturing an optical fiber collimator comprising a single mode optical fiber having an end face thereof and a graded index optical fiber having a first, the method comprising the following steps of: fusing the end face of the single mode optical fiber with the first end face of the graded index optical fiber so that an optical axis of the single mode optical fiber is coincide with an optical axis of graded index optical fiber; coating outer surfaces of the single mode and graded index optical fibers with a protective film; cutting the graded index optical fiber to define a second end faces thereof so that a length between the first and second end faces thereof is a predetermined value to attain an effect as a collimator; etching the second end face of the graded index optical fiber to provide with a bulge portion; and removing the protective film to obtain the optical fiber collimator.

It is preferable that the method further comprising a following step of: coating the second end face of the graded index optical fiber with an antireflection film, after removing the protective film to obtain the optical fiber collimator.

It is also preferable that the bulge portion is formed by etching the second end face of the graded index optical fiber with an etching solution.

In the optical fiber collimator of the present invention, as far as a bulge portion is provided on the end face of the graded index optical fiber, the axial direction of the optical fiber and the optical axis of a beam of light incident upon and emergent from the end face of the optical fiber can be made to perfectly agree with each other. Due to the foregoing, the support structure and the constitution of the support jig used in the case of assembling the optical device, into which the optical fiber collimator is incorporated, can be simplified and the assembling work can be made easy. Since the bulge portion is arranged on the end face of the optical fiber, it is possible to improve a return loss characteristic of the optical fiber collimator. Accordingly, it is possible to provide an optical fiber collimator capable of being put into practical use.

According to the method of manufacturing the optical fiber collimator of the present invention, the bulge portion can be easily formed on the end face of the grated index optical fiber. Therefore, it is possible to easily manufacture an optical fiber collimator in which the axial direction of the optical fiber and the optical axis of a beam of light incident upon and emergent from the end face of the optical fiber are made to perfectly agree with each other.

### BRIEF DESCRIPTION OF THE DRAWINGS

In the drawings:

FIG. 1 is a schematic illustration showing a constitution of the optical fiber collimator of the present invention;

FIG. 2(a) is an enlarged side view showing a neighborhood of the end face of GI optical fiber of the optical fiber collimator;

FIG. 2(b) is a perspective view of the neighborhood of the end face of GI optical fiber of the optical fiber collimator;

FIGS. 3(a) to 3(e) are schematic illustrations showing a method of manufacturing an optical fiber collimator of the present invention; and

FIGS. 4(a) and 4(b) are schematic illustrations showing constitutions of the conventional optical fiber collimators.

### DETAILED DESCRIPTION OF THE PREFERRED EMBODIMENT

Referring to the accompanying drawings, a preferred embodiment of the present invention will be explained in detail below.

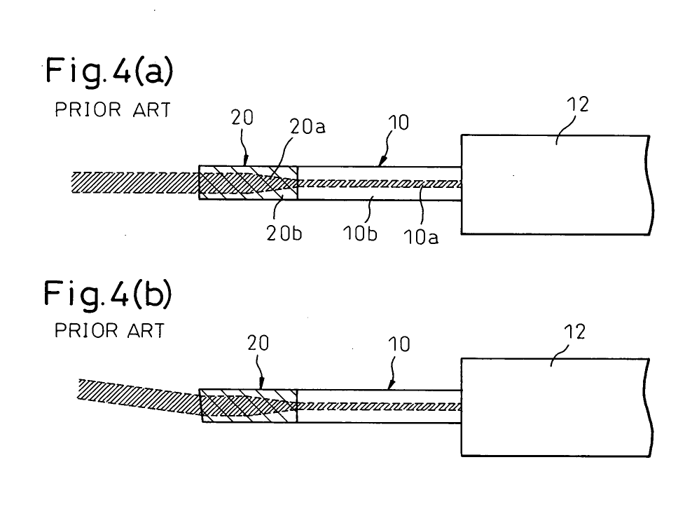

FIG. 1 is a schematic illustration showing an overall arrangement of the optical fiber collimator of the present invention. In the same manner as that of the optical fiber collimator shown in FIG. 4, the optical fiber collimator of the present invention is composed in such a manner that GI optical fiber 12 is fused to an end face of the single mode optical fiber 10. The characteristic of the optical fiber collimator of the present embodiment, which is different from the conventional optical fiber collimator, is that the hemispherical bulge portion 20c is formed on an end face of GI optical fiber 20.

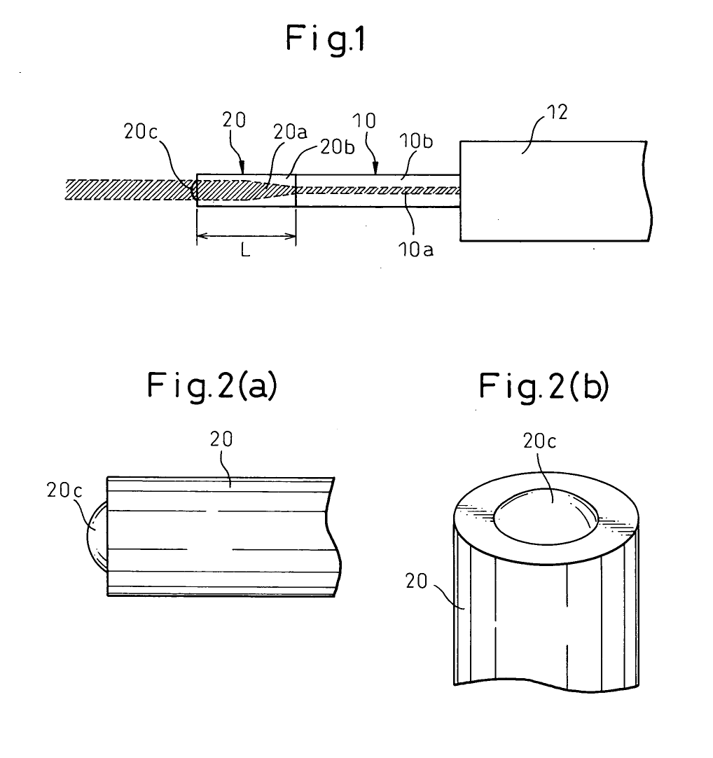

FIGS. 2(a) and 2(b) are enlarged views showing a neighborhood of the end face of GI optical fiber 20. FIG. 2(a) is a side view, and FIG. 2(b) is a perspective view. In the circular end face region of GI optical fiber 20, the bulge portion 20a is formed in such a manner that the outer face is formed into a spherical shape which is symmetrical with respect to the center of GI optical fiber 20. The core portion 20a of the fiber of GI optical fiber 20 is formed so that the refractive index can be gradually changed in the radial direction, and the clad portion of the outer circumference of the core is formed so that the refractive index can be uniform. The bulge portion 20c is provided in the end face region of the optical fiber corresponding to the core portion of GI optical fiber 20.

The optical fiber collimator of the present embodiment is characterized as follows. The bulge portion 20c is formed in a region corresponding to the core portion of the end face of GI optical fiber 20. By the action of this bulge portion 20c, the axial direction of the optical fiber collimator and the optical axis of a beam of light incident upon and emergent from the end face of the optical fiber are made to perfectly agree with each other. Further, since the end face of the optical fiber is formed into a curved face, the return loss characteristic on the end face of the optical fiber can be made to be a return loss characteristic which can be appropriately put into practical use.

The bulge portion 20c formed on the end face of GI optical fiber 20 optically acts as a lens. Accordingly, while consideration is being given to the lens action conducted by the bulge portion 20c, length L of GI optical fiber 20 is determined so that a parallel luminous flux can be emergent from the end face of the optical fiber and a parallel luminous flux incident upon the end face of the optical fiber can be condensed in the core portion of the single mode optical fiber 10.

The optical fiber collimator of the present invention can provide an optical collimating action by the shape of the bulge portion 20c, which is formed on the end face of GI optical fiber 20, and by length L of GI optical fiber 20. Accordingly, it can be said that length L of GI optical fiber 20 is prescribed by the shape of the bulge portion 20c, and the shape of the bulge portion 20c is prescribed by length L of GI optical fiber 20.

Compared with a case in which the end face of the optical fiber collimator is a flat face perpendicular to the axial direction, the return loss characteristic can be greatly improved in the present embodiment in which the bulge portion 20c is formed on the end face of GI optical fiber 20. The reason why the return loss characteristic can be greatly improved is that the bulge portion 20c, the outer face of which is formed into a curved face, is formed on the end face of GI optical fiber 20. In the case where the end face of the optical fiber is a flat face, a beam of light reflected on the end face of the optical fiber is directly returned to the end face of the single mode optical fiber 10. However, in the case where the end face of the optical fiber is a curved face, a beam of light reflected on the end face of the optical fiber is not directly returned to the single mode optical fiber 10.

According to the optical fiber collimator of the present embodiment, when an antireflection film, such as SiO₂ or Ta₂O₅, is not provided on the end face of GI optical fiber 20, the return loss can be not more than −30 dB. When an antireflection film, the transmittance of which is 99.97% (−35 dB reflection), is provided on the end face of GI optical fiber 20, the return loss can be not more than −50 dB. An antireflection film, the transmittance of which is 99.97%, is usually used for the optical fiber collimator, the end face of which is an inclined face. According to the optical fiber collimator of the present embodiment, it is possible to provide a product, the return loss characteristic of which can be put into practical use, in which the axial direction of the optical fiber collimator and the optical axis of the incident and emergent light are perfectly made to agree with each other, without using a particularly complicated manufacturing process.

As a method of forming the bulge portion 20a on the end face of the optical fiber as shown in FIGS. 1, 2(a) and 2(b), the present embodiment employed a method of chemically etching the end face of GI optical fiber 20.

In the present embodiment, GI optical fiber 20 is made of base material of quartz glass, and a quantity of addition of Ge is controlled so that the refractive index can be continuously changed. When the optical fiber, the refractive index of which is continuously changed, is etched in a predetermined etching solution, it is possible to form the bulge portion 20a, the outer face of which is spherical (the outer face of which is curved and protruded outside) as shown in FIGS. 2(a) and 2(b).

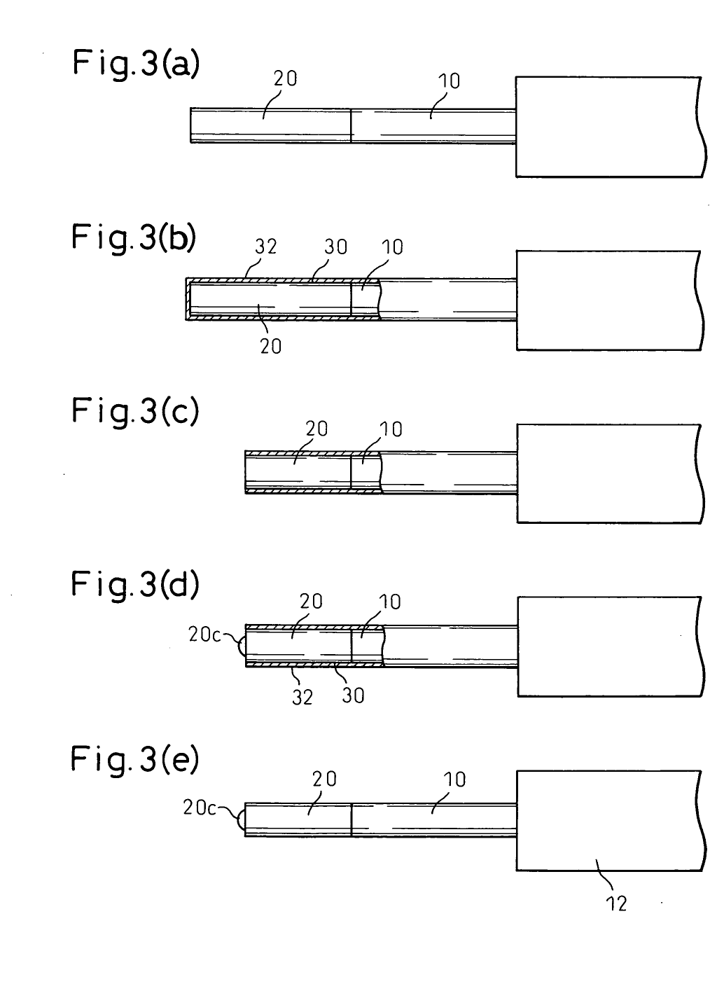

In the present embodiment, the bulge portion 20a is formed on an end face of GI optical fiber 20 as follows. The manufacturing process is shown in FIG. 3.

First, GI optical fiber 20 is fused on an end face of the single mode optical fiber 10 as shown in FIG. 3(a). The length of GI optical fiber 20 is determined somewhat longer than a predetermined length.

Next, in order to protect an outer circumferential face of the optical fiber so that it can not be etched at the time of etching the end face of the optical fiber, electroless nickel plating and electroless gold plating are conducted in this order on the outer circumferential faces of the single mode optical fiber 10 and GI optical fiber 20 so that a protective film for protecting the outer circumferential face of the optical fiber from etching can be formed. FIG. 3(b) is a view showing a state in which the nickel plating layer 30 and the gold plating layer 32 are provided.

Next, GI optical fiber 20 is cut into a predetermined length. The length of GI optical fiber 20 is determined so that a beam of light emergent from the end face of GI optical fiber 20 can be a parallel luminous flux. In the case where the end face of GI optical fiber is cut into a flat face, the length of GI optical fiber 20 is determined to be a length of ¼ of the wave length determined by the convergent constant of GI optical fiber. Alternatively, the length of GI optical fiber 20 is determined to be a length obtained when ¼ of the wave length is multiplied by an odd number. In the case of the present embodiment, since the bulge portion 20c is formed on the end face of GI optical fiber 20, while consideration is being given to the lens action of the bulge portion 20a, the length of GI optical fiber 20 is determined and GI optical fiber 20 is cut into the this determined length.

When GI optical fiber 20 is cut into the predetermined length, an end face of GI optical fiber 20 is exposed, and other portions of the optical fiber are covered with the protective film as shown in FIG. 3(c).

After the end face of GI optical fiber 20 has been exposed, the optical fiber is dipped in an etching solution so as to etch the end face of GI optical fiber 20.

In this embodiment, as the etching solution, a mixed solution is used in which hydrogen fluoride, ammonium fluoride and pure water are mixed by the ratio of 0.2:1.4:1. When etching is conducted by this etching solution, the bulge portion 20c, the outer face of which is spherical, can be formed on the end face of GI optical fiber 20. The return loss of the optical fiber collimator is changed by the etching time. Therefore, when an appropriate etching time is set, a predetermined return loss characteristic can be obtained. FIG. 3(d) is a view showing a state in which the end face of GI optical fiber 20 is etched and the bulge portion 20a is formed on the end face of GI optical fiber 20.

Finally, the gold plating layer 32 and the nickel plating layer 30, which are protective films for covering the outer circumferential face of the optical fiber, are removed by dissolving. In this way, the optical fiber collimator can be obtained as shown in FIG. 3(e).

The thus obtained optical fiber collimator is a product in which the axial direction of the optical fiber collimator and the optical axis of a beam of light incident upon and emergent from the end face of the optical fiber are perfectly aligned on a straight line.

TABLE 1
Change in Return Loss Characteristic

| Etching Time (Hour) | | 1 h | 2 h | 3 h | 4 h |
|---|---|---|---|---|---|
| No “AR” | \mathring{1} | 22.74 | 32.18 | 31.19 | 41.60 |
| ↓ | \mathring{2} | 23.84 | 26.96 | 31.05 | 32.89 |
| ↓ | \mathring{3} | 22.76 | 27.58 | 30.10 | 33.78 |
| ↓ | \mathring{4} | | 29.01 | 31.30 | 41.11 |
| After “AR” | \mathring{1} | 43.21 | 46.56 | 50.84 | 53.39 |
| ↓ | \mathring{2} | 42.49 | 46.67 | 52.31 | 56.78 |
| ↓ | \mathring{3} | 43.42 | 47.26 | 50.00 | 52.49 |
| ↓ | \mathring{4} | | 46.25 | 51.00 | 52.92 |

* Reference value
Single mode optical fiber 0°
Change in return loss value by “AR” coat on end face (Before “AR”) −15 dB → −36 dB (After “AR”)

Table 1 shows a result of the investigation which was made to investigate a change in the return loss characteristic of the optical fiber collimator in the case of changing the etching time in which etching was conducted in an etching solution when the bulge portion 20a was formed on the end face of GI optical fiber 20 by the method of the above embodiment, wherein the investigation was made for four samples.

In this connection, “No AR” described in Table 1 represents a result of the measurement of the return loss characteristic under the condition that the end face of GI optical fiber has been etched, and “After AR” described in Table 1 represents a result of the measurement of the return loss characteristic under the condition that an antireflection film has been provided on the end face of GI optical fiber of the same sample. In this case, the antireflection film was composed of six layers, and the transmittance of the antireflection film was 99.97%.

According to the result shown in Table 1, as the etching time is extended from one hour to four hours, the return loss characteristic is gradually improved, and when the antireflection film is provided, the return loss characteristic is improved. In the case of the etching time of three hours and also in the case of the etching time of four hours, when the antireflection film is provided, the return loss characteristic of not more than −50 dB is obtained. Products of the above etching time can be sufficiently put into practical use.

In this connection, when the etching time of etching the end face of GI optical fiber is changed, the shape (the radius of curvature) of the bulge portion 20c, which is formed on the end face of GI optical fiber 20, is changed. Therefore, it can be said that the return loss is not enhanced simply when the etching time is extended. Actually, it is necessary to conduct etching after the most appropriate etching time for a product has been set.

TABLE 2
Characteristic data of GI Fiber

| | Sample A | Sample B |
|---|---|---|
| Diameter of core | 50 um | 100 um |
| Diameter of clad | 125 um | 125 um |
| Specific refrection index | 1.1% | 0.85% |
| Distributed constant of | 2 | 2 |
| referection index | | |

TABLE 3
Change in return loss value, before and
after “AR” coating, in case of No etching
process

| | Before “AR” coating | After “AR” coating |
|---|---|---|
| \mathring{1} | 14.6 | 37.68 |
| \mathring{2} | 14.7 | 36.27 |
| \mathring{3} | 14.9 | 37.23 |
| \mathring{4} | 14.3 | 35.47 |

(dB)

Table 2 show characteristic data of some samples of the GI optical fibers which can be used in this embodiment. Table 3 show a result of investigation which is was made to investigate a change in the return loss characteristic of the optical fiber collimator, under the same conditions as the above, but no etching process was carried out.

As described above in this embodiment, the method of forming the bulge portion 20c on the end face of GI optical fiber 20 by chemically etching the end face of GI optical fiber 20 is very preferable as a method of forming the outer face of the bulge portion 20a into a convex curved shape. Since the core of GI optical fiber 20 is designed so that the refractive index can be gradually changed in the radial direction, by utilizing the characteristic of the composition of GI optical fiber 20, the bulge portion 20c, the outer face of which is smooth, can be formed only by the chemical etching operation.

Therefore, a predetermined collimating effect can be provided by the optical lens action of the bulge portion 20c and by the optical action of GI optical fiber 20. Further, the return loss characteristic can be improved by the bulge portion 20c.

In this connection, the reason why the outer circumferential face of the optical fiber is covered with a protective film in the case of etching the end face of GI optical fiber is that portions except for the end face of GI optical fiber 20 is prevented from being etched by the etching solution. In this case, the protective film is not particularly limited to a specific type. In the present embodiment, plating is conducted on the outer face of the optical fiber so as to compose a protective film. However, instead of providing the protective film by means of plating, it is possible to employ a method of covering the outer face of the optical fiber with some other material such as resin which is not etched by the etching solution.

GI optical fiber 20 of the present embodiment is made of base material of quartz. However, even in the case of an optical fiber made of resin, the bulge portion can be formed on the end face of GI optical fiber by utilizing the etching method in the same manner as that of the above embodiment.

Concerning the method of forming the curved-face-shaped bulge portion 20c, the outer face of which is smooth, on the end face of GI optical fiber 20, it is possible to employ a method of etching by utilizing the etching solution but also a method of utilizing a physical method such as a method of plasma etching. In other words, the method of forming the bulge portion 20c on the end face of GI optical fiber 20 is not limited to the chemical etching method.

In the above embodiment, the bulge portion 20 formed on the end face of GI optical fiber 20 is formed being integrated with GI optical fiber 20 into one body. However, it is possible to compose the bulge portion 20c as a different body from GI optical fiber 20. For example, it is possible to employ a method in which a lens body having a predetermined lens action, which is composed differently from GI optical fiber 20, is bonded to the end face of GI optical fiber 20. Alternatively, it is possible to employ a method in which a bulge portion having a smooth outer face is formed on the end face of GI optical fiber 20 by coating a transparent resin paste onto the end face of GI optical fiber 20.

1. An optical fiber collimator comprising:
a single mode optical fiber having an end face thereof;
a graded index optical fiber having a first end face fused to the end face of the single mode optical fiber so that an optical axis of the single mode optical fiber is coincide with an optical axis of graded index optical fiber to effect an optical transmission between these fibers; and
the graded index optical fiber having a second end face provided with a bulge portion defining a smooth outer surface symmetrical with respect to the common optical axis of the single mode and graded index optical fibers.

2. An optical fiber collimator as set forth in claim 1, wherein the bulge portion is formed integrally with the graded index optical fiber.

3. An optical fiber collimator as set forth in claim 1, wherein the graded index optical fiber comprises a central graded index core extending along the optical axis thereof and a clad surrounding the core, and the bulge portion is formed at the graded index optical fiber.

4. An optical fiber collimator as set forth in claim 1, wherein the bulge portion is formed by etching the second end of the graded index core.

5. An optical fiber collimator as set forth in claim 1, wherein the second end face of the graded index core is coated with an antireflection film.

6. A method of manufacturing an optical fiber collimator comprising a single mode optical fiber having an end face thereof and a graded index optical fiber having a first, the method comprising the following steps of:
fusing the end face of the single mode optical fiber with the first end face of the graded index optical fiber so that an optical axis of the single mode optical fiber is coincide with an optical axis of graded index optical fiber;
coating outer surfaces of the single mode and graded index optical fibers with a protective film;
cutting the graded index optical fiber to define a second end faces thereof so that a length between the first and second end faces thereof is a predetermined value to attain an effect as a collimator;
etching the second end face of the graded index optical fiber to provide with a bulge portion; and
removing the protective film to obtain the optical fiber collimator.

7. A method as set forth in claim 6, the method further comprising a following step of:
coating the second end face of the graded index optical fiber with an antireflection film, after removing the protective film to obtain the optical fiber collimator.

8. A method as set forth in claim 6, wherein the bulge portion is formed by etching the second end face of the graded index optical fiber with an etching solution.
